(19) United States
(12) Patent Application Publication
(10) Pub. No.: US 2006/0108425 A1
(43) Pub. Date: May 25, 2006

(54) Partitioned bar code system and method

(75) Inventor: Christopher A. Wiklof, Everett, WA (US)

Correspondence Address: MERCHANT & GOULD PC, P.O. BOX 2903, MINNEAPOLIS, MN, 55402-0903, US

(73) Assignee: Microvision, Inc., Bothell, WA (US)

(21) Appl. No.: 10/996,982

(22) Filed: Nov. 23, 2004

(51) Int. Cl. G06K 7/10

(52) U.S. Cl. 235/462.44

(57) ABSTRACT

A bar code scanner includes at least three components, namely, a beam source, a beam director, and a detector. The at least three components are arranged in at least two physically distinct portions that are separately enclosed and spatially separated from one another. In one example, the beam source is embodied on a ring that is worn on a user's finger, while the beam director is embodied in another ring that is worn on a different finger of the user such that the beam source and the beam director are coupled to one another via a spatial gap in open air. In another example, the beam source, beam director, and detector are embodied in separate physical portions that are each located on separate substrates that are affixed to a glove that is worn by a user.

### FIELD OF THE INVENTION

The present invention generally relates to bar code scanners. More particularly, the present disclosure relates to a bar code scanner that includes a beam source, a beam director, and a detector that are arranged in at least two physically distinct portions.

### BACKGROUND

A variety of electrical circuits, optics, and electro-optical systems have been developed for the purposes of reading indicia that may appear on a label, surface of an article, or any of a variety of other locations. The indicia are commonly associated with encoded data such as may be found in bar code symbologies, which have reached wide spread acceptance across a wide range of markets. Conventional linear bar code symbologies encode data as a series of variable width bars separated by variable width spaces. Two-dimensional symbologies include 2D stacked and 2D matrix variants that encode data as a stacked set of linear segments or as presence/absence in a checkerboard pattern, respectively. In general, the bar code is formed as a set of graphical bars that are printed with dark ink on a light colored background to form the spaces. Some bar code symbology information related to the disclosure is described in “The Bar Code Book”, by Roger C. Palmer, which is hereby incorporated by reference.

One particularly successful and widespread family of bar code symbologies is the UPC/EAN/JAN family. This group of bar code symbologies is used to uniquely identify virtually every type of pre-packaged retail item sold in i.e. U.S. and Canada, Europe, and Japan, respectively. Bar code readers and scanning systems are arranged to evaluate the graphical bars and spaces to detect and decode the bar code into a series of numeric characters that associate the retail item with a database. Other symbologies encode alphanumeric and larger character sets. A light beam is scanned over the surface of the bar code such that a portion of the light is reflected off of the bar code and received by a detector. The detector is arranged to provide (analog or digital) electrical signals that correspond to amplitudes of the reflected light. A signal processing system in the scanner analyses the electrical signal and translates (or decodes) the scanned characters into a digital representation. The digital representation of the decoded characters may be collected for use in an inventory control system, point-of-sale processing system, as well as any other appropriate use.

Recent efforts in bar code scanner technologies have yielded a number of portable scanning solutions. Hand held scanner units that are connected to hip-based processing units are now commonly available. Another portable scanner technology that has been developed includes a bar code scanner unit that is mounted on the back of the hand as illustrated in U.S. Pat. Nos. 6,015,090 and 6,637,659. Yet another portable scanner technology that has been developed that includes a bar code scanner unit that is worn on a user's finger as illustrated in U.S. Pat. No. 6,607,134.

### BRIEF DESCRIPTION OF THE DRAWINGS

Non-limiting and non-exhaustive embodiments of the present invention are described with reference to the following drawings.

FIGS. 1A-1C are illustrations of bar code scanning devices as used by a user;

FIG. 2 is an illustration of an example bar code scanning device that is embodied in three physically separate bodies;

FIGS. 3-5 are illustrations of example bar code scanning devices that include two physically separated bodies;

FIG. 6 is an illustration of an example bar code scanning device that is embodied in two physically separated bodies that are arranged as a pair of rings that may be worn by a user;

FIG. 7 is an illustration of an example MEMS beam director.

### DETAILED DESCRIPTION

Various embodiments will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. The meaning of “in” may include “in” and “on.” The term “connected” may mean a direct electrical, electromagnetic, mechanical, logical, or other connection between the items connected, without any electrical, mechanical, logical or other intermediary therebetween. The term “coupled” can mean a direct connection between items, an indirect connection through one or more intermediaries, or communication between items in a manner that may not constitute a connection. The term “circuit” can mean a single component or a plurality of components, active and/or passive, discrete or integrated, that are coupled together to provide a desired function. The term “signal” can mean at least one current, voltage, charge, temperature, data, electromagnetic field, electromagnetic beam, electromagnetic wave, pressure wave, or other.

Briefly stated, the present disclosure generally relates to a bar code scanner that includes at least three components, namely, a beam source, a beam director, and a detector. The at least three components are arranged in at least two physically distinct portions that are separately held and spatially separated from one another. The at least two physically distinct portions include at least one relationship therebetween that may be characterized as momentary alignment. In one example, the beam source is embodied on a ring that is worn on a user's finger, while the beam director is embodied in another ring that is worn on a different finger of the user such that the beam source and the beam director are coupled to one another in momentary alignment via a spatial gap in open air. In another example, the beam source, beam director, and detector are embodied in separate physical portions that are each located on separate bodies that are affixed to a glove that may be worn by a user.

Illustrative Operating Environments

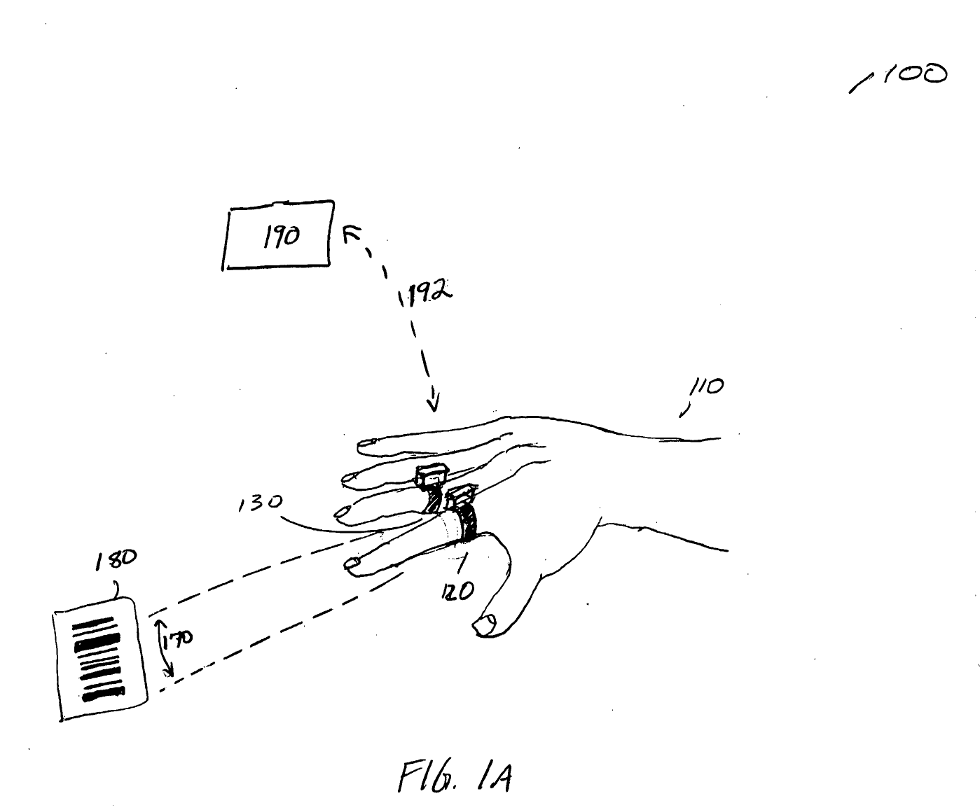

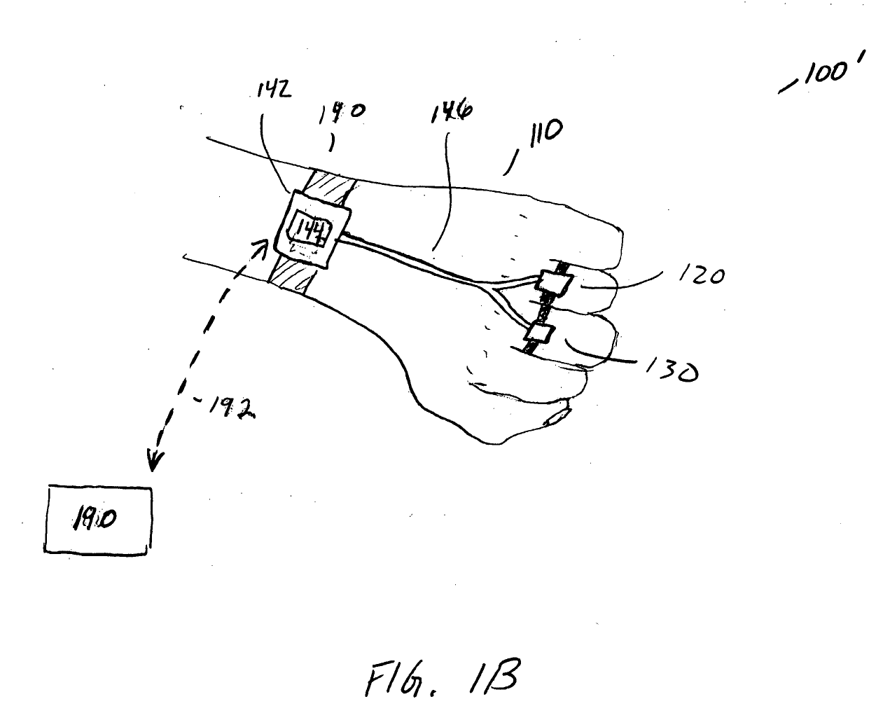

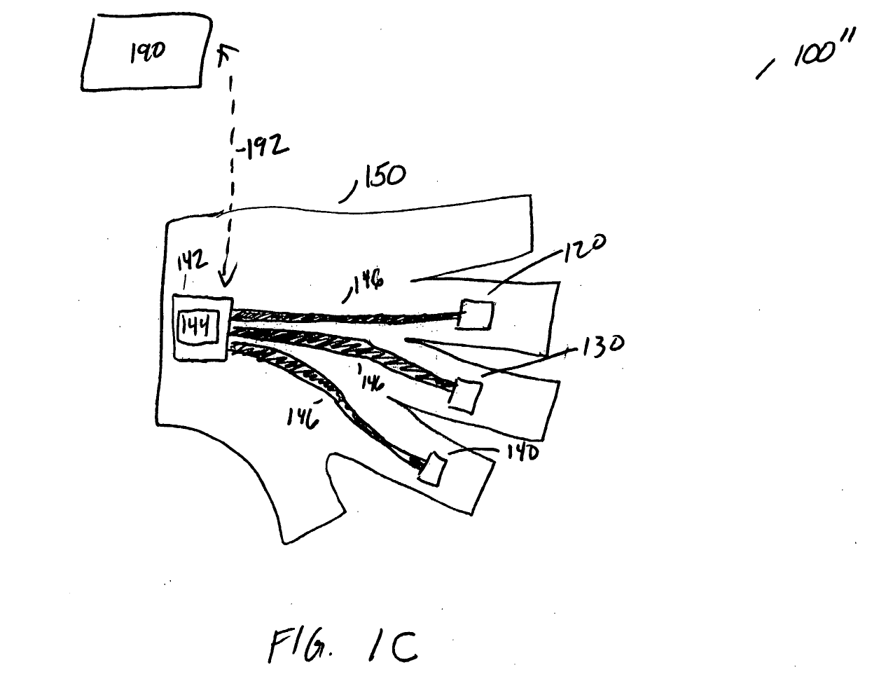

FIGS. 1A-1C are illustrations of bar code scanning devices (100, 100′ and 100″). Each example bar code scanning device is illustrated in an operating environment where the devices are worn about the hand or fingers of a user.

Referring to FIG. 1A, bar code scanning device 100 includes two bodies (120 and 130) Body 120 is worn on one finger of the user's hand (110), while body 130 is worn on another finger. In this example, body 120 includes a beam director, while body 130 includes a beam source. At least one of bodies 120 and 130 further includes a detector. The beam source is arranged to cooperate with the beam director to scan the light beam over a desired field of view (170) for scanning a bar code symbol (180) when the two bodies 120 and 130 are held in appropriate alignment. Light that is reflected from the bar code symbol is received by the detector and converted into one or more signals that correspond to the bar code pattern. The signals are communicated to a processing unit (190) through a physically wired connection or a wireless connection (192). Processing unit 190 evaluates the signals to determine the information encoded in the bar code symbol, and performs other data logging and data processing functions as appropriate. Alternatively, processing unit 190 may be included within body 120 and/or 130. In the event where processing unit 190 is so integrated, it may be advantageous to co-locate processing unit 190 with the detector.

Similarly, FIG. 1B, illustrates another bar code scanning device (100′) that includes two bodies (120 and 130) that are adapted for use by a user. Once again, body 120 is worn on one finger of the user's hand (110), while body 130 is worn on another finger. In one example, body 120 includes a beam director and body 130 includes a beam source and a detector. In another example, body 120 includes a beam source and body 130 includes a beam director and a detector. The beam source is arranged to cooperate with the beam director to scan the light beam over a desired field of view (not shown) for scanning a bar code symbol (not shown) when the beam source body 120 and the beam director body 13 are held in appropriate alignment. Light that is reflected from the bar code symbol is received by the detector and converted into one or more signals representative of the pattern of the bar code. The signals are communicated to a wrist worn processing unit (140) through a physically wired connection (146) or via a wireless connection. The processing unit (140) includes a housing (142) that includes an electronic circuit (144). Electronic circuit 144 may provide power to either of bodies 120 and 130 as may be necessary, as well as provide additional timing control, decoding, and other necessary functions. In one example, processing unit 140 is arranged communicate with another processing unit (190) directly or indirectly via a wired, wireless, or other connection (192). Processing unit 190 may be arranged to further evaluate signals, and provide other data logging and data processing functions.

FIG. 1C illustrates still another bar code scanning device (100″) that includes three bodies (120, 130 and 140) that are adapted for use by a user on a glove (150). Bodies 120, 130 and 140 are affixed to glove 150 on respective finger sections of the glove (150). A processing unit (142) may also be affixed to the glove (150), for example at a location on the back of the hand or wrist area. Alternatively, processing unit 142 may be integrated into one or more of bodies 120, 130 and/or 140 or located separately from the glove. Processing unit 142 includes an electronic circuit (144) that may be coupled to each of bodies 120, 130 and 140 through wireless or wired connection (146). Electronic circuit 144 may provide power as necessary for bodies (120, 130 and 140), as well as provide timing control, decoding, and other necessary functions. In an example embodiment, processing unit 140 is arranged to communicate with another processing unit (190) via a wired or wireless connection (192). Processing unit 190 may be arranged to further evaluate signals, and provide other data logging and data processing functions.

A portion, or all, of the processing units (190) described above may be a located within a host computer system such as may be used for data logging, inventory control, price costing analysis or any other processing or data logging operations. In one example, processing unit 190 is contained in a user-worn (e.g., on a belt clip) data logging apparatus. In another example, processing unit 190 is located within a computer system that is accessible over a networked, host-client, or point-to-point computer such as a wired or wireless network (e.g., 802.11a/b/g, Bluetooth, IR, etc.).

General Discussion of Example Devices

Each example bar code scanning device that is described below includes at least two bodies that are physically separated from one another. Each body of the bar code scanner device is reduced in size relative to conventional bar code scanning devices such that a very compact and portable set of bodies results. In some examples, momentary alignment between two or more of the bodies may be necessary during a scanning operation, where the momentary alignment is sufficient in time to permit decoding a bar code symbol.

Momentary or transitory alignment between the bodies can be assisted by one or more optional optical elements/devices. Additional optical elements or optical devices may also be necessary to shape, collimate, and/or focus the beam provided by at least one of the bodies. Non-limiting examples of optical elements and devices includes one or more lenses, apertures, mirrors, diffractive members, refractive members, or other devices. The optical elements can be formed, affixed to, or otherwise arranged to operate with at least one of the bodies to assist in processing the beam as may be required.

In one example, coarse alignment is provided by the natural skeletal structure of the user such as by the relative positions of fingers on a hand. For this example, momentary or transitory alignment may be achieved when a user momentarily aligns the bodies mounted on their fingers. In another example, alignment of the bodies relative to one another may be temporary, such as when a user dons a glove carrying the bodies. Additional adjustment features may be used to allow the user to further align or roughly align or fit the bodies to account for the user's sometimes unique physical characteristics.

First Example Device

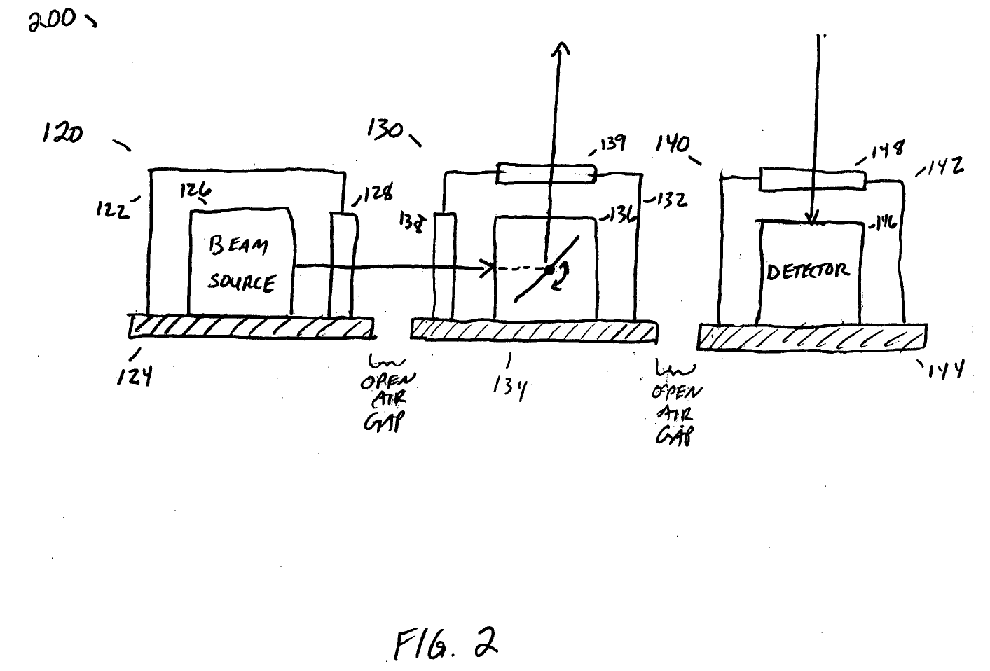

FIG. 2 is a diagram of an example bar code scanning device (200) that is embodied in three physically separated bodies (120, 130 and 140). The bodies (120, 130 and 140) are physically separated from one another as illustrated by open-air gaps between their respective physical locations. Bar code scanning device (200) is operative when bodies 120, 130, and 140 are held in alignment sufficient to decode a bar code symbol. As described previously, such alignment may be momentary or transitory, such as when a user momentarily aligns bodies mounted on his or her fingers. Alternatively, such alignment may be temporary, such as when a user dons a glove carrying the bodies. For temporary or momentary alignment embodiments, adjustment features (not shown) may be used to allow the user to align or roughly align or fit the bodies to accommodate the user's physical characteristics.

The first body (120) includes a first housing (122), a first substrate (124), and a beam source (126). Beam source 126 may include one or more lenses, apertures, etc to collimate, shape, and/or focus the beam. Body 120 optionally includes one or more lenses, mirrors, diffractive members, or other devices (128) operative to aid in the alignment of body 120 with body 130.

The second body (130) includes a second housing (132), a second substrate (134), and a beam director (136). Body 130 optionally includes a lens, mirror, diffraction member, or other device (138) operative to aid in the optical alignment of body 120 with body 130. Body 130 also optionally includes another optical member (139) such as a lens or some other similarly functioning optical device that is arranged to focus, filter, collimate, shape or otherwise process the light beam that is provided by the beam director (136) to the bar code in the field of view. In one example, optical member 139 is operative to expand the beam sweep angle produced by beam director 136. In another example, optical member 139 is operative to cut off or mask the outer ends of the beam sweep angle that may fall outside the field of view of detector 146.

The third body (140) includes a third housing (142), a third substrate (144), and a detector (146). Body 140 optionally includes a lens or some other similarly functioning optical member or device (148) that is arranged to focus and/or filter the light that is reflected from the bar code symbol (not shown) onto the detector (146). Optical device 148 may further include provisions to variably (such as position dependently) filter the light reflected from the bar code symbol to account for variations such as in optical coupling efficiency. Such variable filtering may be accomplished by a variable gradient filter, for example. Optical device 148 may further be operative to mask or otherwise exclude light from directions unlikely to subtend a scanned bar code symbol.

Second Example Device

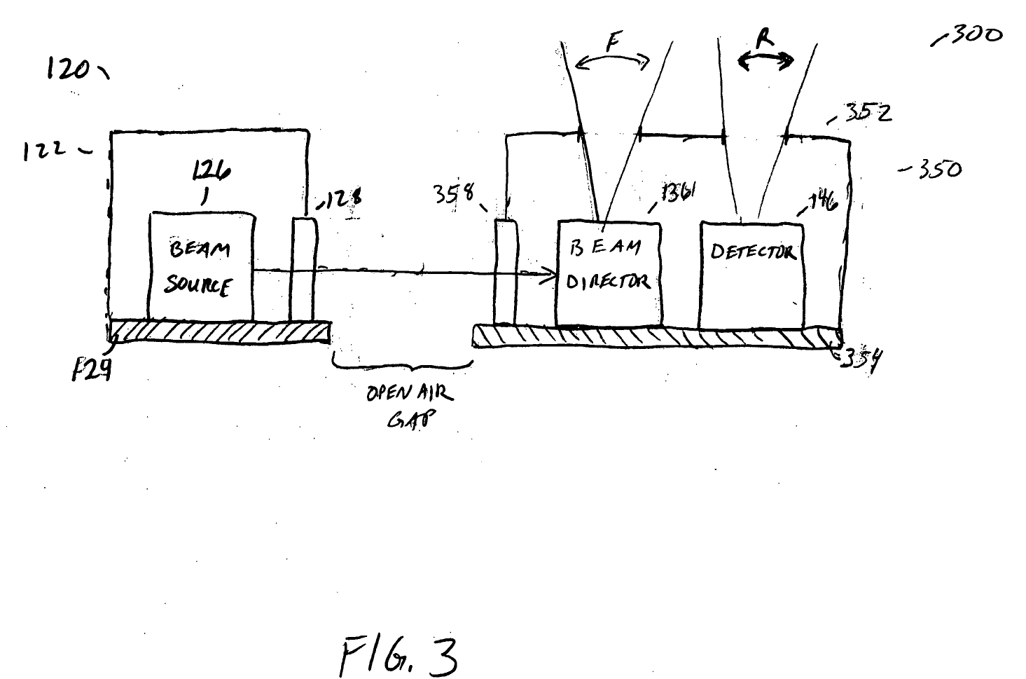

FIG. 3 is an illustration of an example bar code scanning device (300) that includes two physically separated bodies (120 and 350) that are arranged according to at least one aspect of the present disclosure. The bodies (120 and 350) are physically separated from one another as illustrated by the open-air gap between their respective physical locations. Bar code scanning device (300) is operative when bodies 120 and 350 are held in alignment sufficient to decode a bar code symbol. As described previously, such alignment may be momentary or transitory, such as when a user momentarily aligns bodies mounted on his or her fingers. Alternatively, such alignment may be temporary, such as when a user dons a glove carrying the bodies. For temporary or momentary alignment embodiments, adjustment features (not shown) may be used to allow the user to align or roughly align or fit the bodies to accommodate the user's physical characteristics.

The first body (120) includes a first housing (122), a first substrate (124), and a beam source (126). Beam source 126 may include one or more lenses, apertures, etc to collimate, shape, and/or focus the beam. Body 120 optionally includes one or more lenses, mirrors, diffractive members, or other devices (128) operative to aid in the alignment of body 120 with body 350.

The second body (350) includes a second housing (352), a second substrate (354), a beam director (136), and a detector (146). Body 350 optionally includes a lens, mirror, diffraction member, or other device (358) operative to aid in the optical alignment of body 120 with body 350. Body 350 also optionally includes additional optical members (see prior discussion related to FIG. 2) similar to those illustrated as optical members 139 and 148 from FIG. 2. Otherwise, body 350 may merely contain an aperture for the scanning field (F) of the beam director (136) and another aperture for the detection range (R) of the detector (146).

Third Example Device

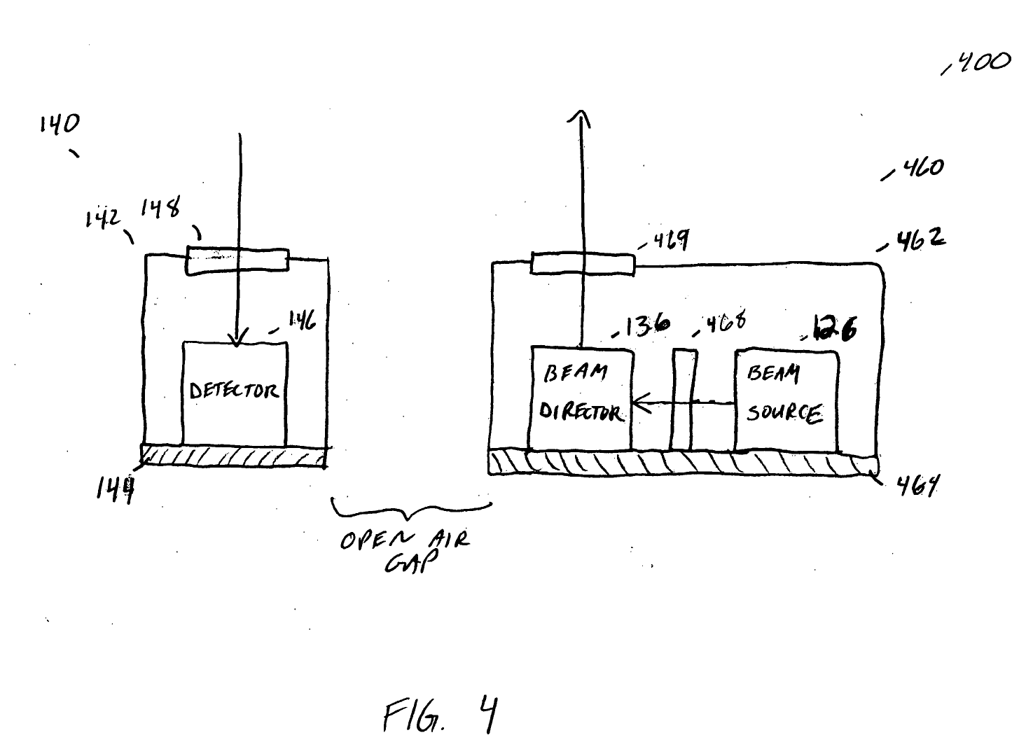

FIG. 4 is an illustration of an example bar code scanning device (400) that includes two physically separated bodies (140 and 460) that are arranged according to at least one aspect of the present disclosure. The bodies (140 and 460) are physically separated from one another as illustrated by the open-air gap between their respective physical locations. Bar code scanning device (400) is operative when bodies 140 and 460 are held in alignment sufficient to decode a bar code symbol (e.g., the scanning field and the detection range are sufficiently similar such that a bar code symbol may be decoded). As described previously, such alignment may be momentary or transitory, such as when a user momentarily aligns bodies mounted on his or her fingers. Alternatively, such alignment may be temporary, such as when a user dons a glove carrying the bodies. For temporary or momentary alignment embodiments, adjustment features (not shown) may be used to allow the user to align or roughly align or fit the bodies to accommodate the user's physical characteristics.

The first body (140) includes a first housing (142), a first substrate (144), and a detector (146). Body 140 optionally includes a lens (148) or some other similarly functioning optical member or device that is arranged to focus and/or filter the light that is reflected from the bar code symbol (not shown) on the detector (146). As previously described with respect to FIG. 2 (see prior discussion), optical device 148 may additionally include provisions to variably filter the light reflected from the bar code symbol, or to mask or otherwise exclude light from directions unlikely to subtend a scanned bar code symbol.

The second body (460) includes a second housing (462), a second substrate (464), a beam director (136), and a beam source (126). The beam director (136) and the beam source (126) are affixed to the second substrate (464), and enclosed by the second housing (462). Body 460 optionally includes a lens (468) or some other similarly functioning optical device that is arranged to focus, filter, collimate, shape or otherwise process the light beam that is provided by the beam source (126) to the beam director (136). Body 460 also optionally includes an additional lens (469) or some other similarly functioning optical device that is arranged to focus, filter, collimate, shape or otherwise process the light beam that is provided by the beam director (136) to the bar code in the field of view.

Fourth Example Device

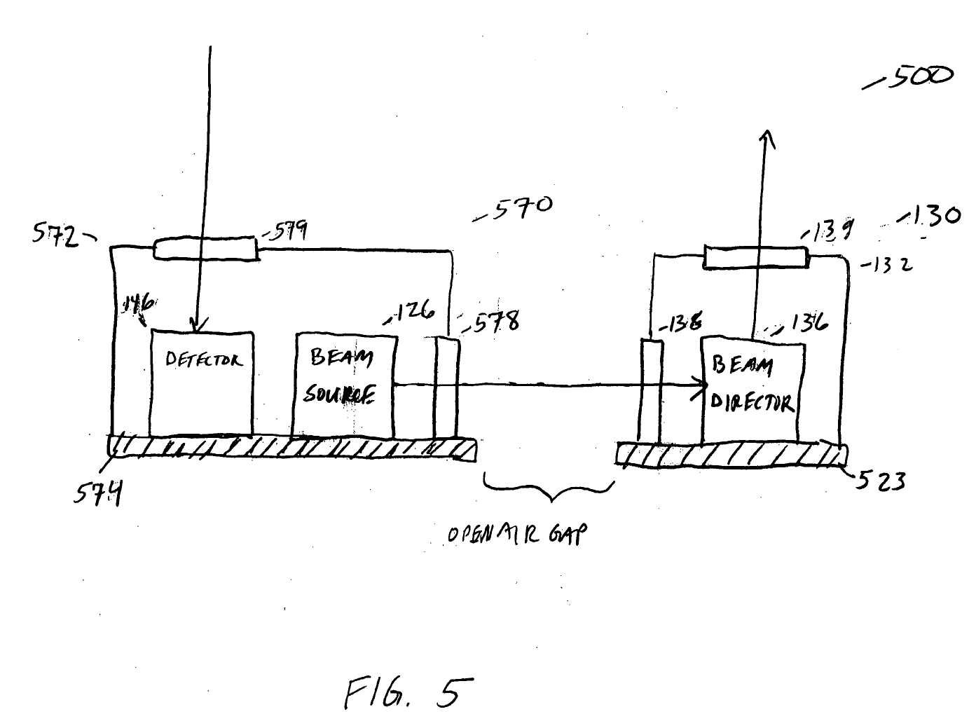

FIG. 5 is an illustration of another example bar code scanning device (500) that includes two physically separated bodies (570 and 130) that are arranged according to at least one aspect of the present disclosure. The bodies (570 and 130) are physically separated from one another as illustrated by the open-air gap between their respective physical locations. Bar code scanning device (500) is operative when bodies 570 and 130 are held in alignment sufficient to decode a bar code symbol. As described previously, such alignment may be momentary or transitory, such as when a user momentarily aligns bodies mounted on his or her fingers. Alternatively, such alignment may be temporary, such as when a user dons a glove carrying the bodies. For temporary or momentary alignment embodiments, adjustment features (not shown) may be used to allow the user to align or roughly align or fit the bodies to accommodate the user's physical characteristics.

The first body (570) includes a first housing (572), a first substrate (574), a detector (146), and a beam source (126). Beam source 126 may include one or more lenses, apertures, etc to collimate, shape, and/or focus the beam. Body 570 optionally includes one or more lenses, mirrors, diffractive members or other devices (578) operative to aid in the alignment of body 570 to body 130. Body 570 also optionally includes a lens or some other similarly functioning optical member or device (579) that is arranged to focus and/or filter the light that is reflected from the bar code symbol (not shown) onto the detector (146). Optical device 579 may further include provisions to variably (such as position dependently) filter the light reflected from the bar code symbol to account for variations such as in optical coupling efficiency. Such variable filtering may be accomplished by a variable gradient filter, for example. Optical device 579 may further be operative to mask or otherwise exclude light from directions unlikely to subtend a scanned bar code symbol.

The second body (130) includes a second housing (132), a second substrate (134), and a beam director (136). The beam director (136) is affixed to the second substrate (134), and enclosed by the second housing (132). Body 130 optionally includes a lens, mirror, diffractive member, or other device (138) operative to aid in the optical alignment of body 130 with body 570. Body 130 also optionally includes another optical member (139) such as a lens or some other similarly functioning optical device that is arranged to focus, filter, collimate, shape or otherwise process the light beam that is provided by the beam director (136) to the bar code in the field of view. In one example, optical member 139 is operative to expand the beam sweep angle produced by beam director 136. In another example, optical member 139 is operative to cut off or mask the outer ends of the beam sweep angle that may fall outside the field of view of detector 146.

Substrates that are described in the above examples refer generally to support or carrying structures that may take many forms. For example, a substrate may have an adjacent, subjacent, circumjacent, superjacent, or other spatial relationship to a body. A substrate may be rigid, such as a substrate embodied as a ring; or may exhibit at least a degree of flexibility, such as a substrate embodied as a soft glove; or may exhibit a combination of soft and rigid properties.

Substrates for each body need not necessarily be either continuous discontinuous. For example, a glove (as indicated by the exemplary embodiment of FIG. 1C) may serve as a continuous substrate for two or more bodies, whereas a bracelet and glove may serve as discontinuous substrates. Substrates may further include features for aiding alignment with other substrates. For example, a pair of finger rings used as neighboring substrates may include features such as mating saddle-points that are operative to pull respective bodies into alignment when a user squeezes his or her fingers together. Although illustrated for clarity as being planar, substrates are not restricted to a planar or other arbitrary shape.

Bodies may be affixed to substrates by permanent or non-permanent fastening means. For example, in a non-permanent embodiment, bodies may include hooks and a hat brim may include loops that cooperate, when the bodies are placed in contact with the brim, to form a removable hook-and-loop (e.g. VELCRO) attachment system. Alternatively, a body may be formed integrally with its substrate.

The housing materials may be unnecessary in some examples such as where: the beam source is self-contained in its own housing, the beam director is self-contained in its own housing, or when the detector is self-contained in its own housing.

Example Ring Style Devices

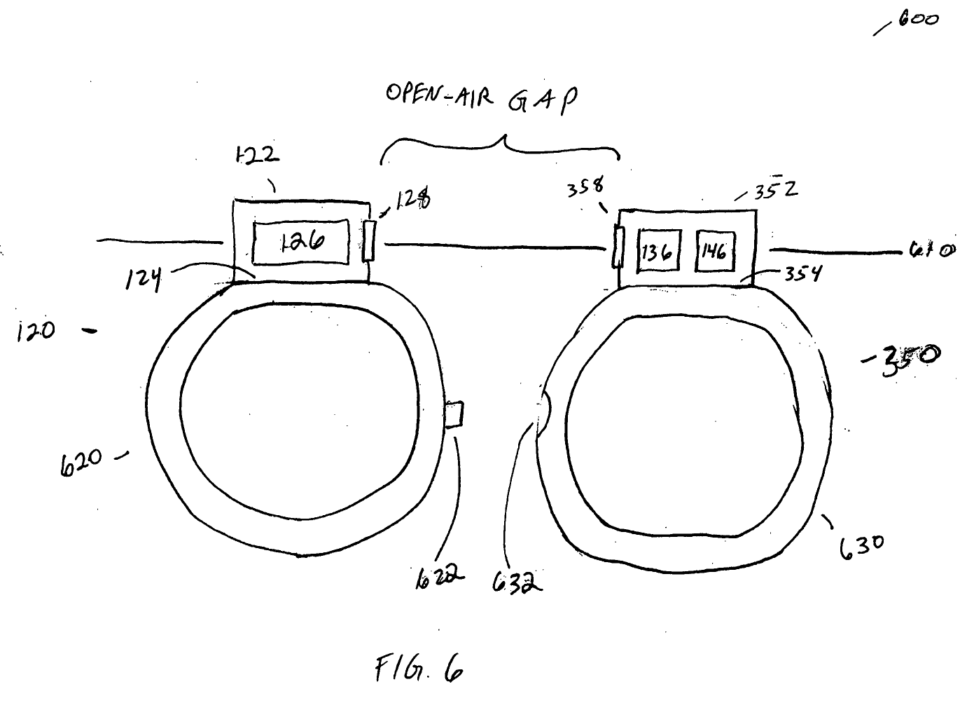

FIG. 6 is an illustration of an example bar code scanning device (600) that is embodied in two physically separated bodies (120 and 350) that are arranged as a pair of rings that may be worn by a user, in accordance with at least one aspect of the present disclosure. The bodies (120 and 350) are physically separated from one another as illustrated by the open-air gap between their respective physical locations.

The first body (120) includes a first housing (122), a first substrate (124), and a beam source (126). The beam source (126) is affixed to the first substrate (124), and enclosed by the first housing (122). Body 120 optionally includes a lens (128) or some other similarly functioning optical device that is arranged to focus, filter, collimate, shape or otherwise process the light beam that is provided by the beam source (126). The first substrate (124) may be formed from a surface of a first ring (620), or affixed to the surface of the first ring (620). The first ring (620) may further include a switching mechanism (122) such as a push button or an electrical contact that is formed on the body of the first ring (620) for activating the beam source (126).

The second body (350) includes a second housing (352), a second substrate (354), a beam director (136), and a detector (146). The beam director (136) and the detector (146) are affixed to the second substrate (354), and enclosed by the second housing (352). Body 350 optionally includes a lens (358) or some other similarly functioning optical device that is arranged to focus, filter, collimate, shape or otherwise process the light beam that is provided by the beam source (126) to the beam director (136). Body 350 also optionally includes an additional lens (not shown) or some other similarly functioning optical device that is arranged to focus, filter, collimate, shape, or otherwise process the light beam that is provided by the beam director (136) to the bar code in the field of view. Body 350 may also optionally include another lens (not show) or some other similar functioning optical device that is arranged to focus, filter, collimate, shape, or otherwise process the light beam that is provided to the detector (146) as a reflection from a bar code. The second substrate (354) may be formed from a surface of a second ring (630), or affixed to the surface of the second ring (630). The second ring (630) may further include a switching mechanism (632) such as a push-button, or an electrical contact that is formed on the body of the second ring (630) for activating the beam director (136) and/or the detector (146).

The electrical contacts between the rings can also be used to transfer information between the bodies, or to activate the devices therein. For example, when the beam director and the detector are in separate rings, information can be transferred between the bodies such as: turn on power,.scanning is active, and scanning is complete. For portable applications, power can be turned off after either a good read signal is interpreted, or when a timeout occurs.

Physical contact may be used in place of or in addition to the optional electrical contact between bodies. For example, a pushbutton on one or both bodies may depress when the rings are squeezed together. In another example, the beam of light produced by the beam source may illuminate a photo switch that initiates scanning by the beam director. In other examples, capacitive, pressure, magnetic, or other effects may be used to inform one or more bodies of the alignment of another body, and hence the user's intent to scan.

Additional Points

The optional switching mechanisms (622 and 632) may be formed such that they mesh together. In one example, switching mechanism 622 is a push-button that meshes together with a detent in the second ring (630). In another example, switching mechanism 622 is a male electrical contact that that mates with a female electrical contact in the second ring (630). In light of the instant disclosure, one of ordinary skill in the art would understand other variations of switching mechanisms that may be useful in selectively activating the various components from the rings.

The ring style-bodies illustrated in FIG. 6 are substantially similar in arrangement to that illustrated by FIG. 3. However, the ring-style implementations are not limited to the embodiment illustrated in FIG. 3, and may be adapted for other embodiments such as those illustrated by FIGS. 2, 4 and 5 as previously described.

The beam sources that are described above may be any appropriate light source that has an appropriate shape and spot size, brightness sufficient to overcome ambient light, and wavelength (e.g., 650 nm-670 nm) for use in scanning applications. In one example, the beam source includes a light emitting diode (LED). In another example, the beam source includes a laser diode. In still another example, the beam source includes one or more additional optical processing elements, such as an anti-stigmatism lens, one or more prisms to circularize the spot shape, a convex lens to provide a collimated beam, as well as any other appropriate optical shaping, focusing, or filtering device.

The beam directors that are described above may be an appropriate light-beam deflecting device that is arranged to produce a scanning beam. The beam director can be an active device such as one driven by an electronically controlled circuit, or a passive device such as a resonant device that has a natural oscillation frequency and that may be mechanically excited. In the case of the latter, the oscillation of the beam director may be activated periodically by naturally occurring body tremors or may be activated by appropriate frequency content of an impulse such as the user swinging his or her hand into alignment with a bar code symbol. The mirrored surface can include a range of embodiments as known to the art including a metal materially such as Aluminum, Gold, Silver, a polished surface, a dielectric mirror, etc. In one example, the beam director is an oscillating mirror-type device that is arranged to sweep the scanning beam along a single axis. In another example, the beam director is an oscillating mirror-type device that is arranged to sweep the scanning beam along two axes (such as a raster scanning mirror). In still another example, the beam director is a micro-electro-mechanical system (MEMS) type of scanner that may include some or all of mechanical elements, sensors, actuators, and electronics that are optionally integrated.

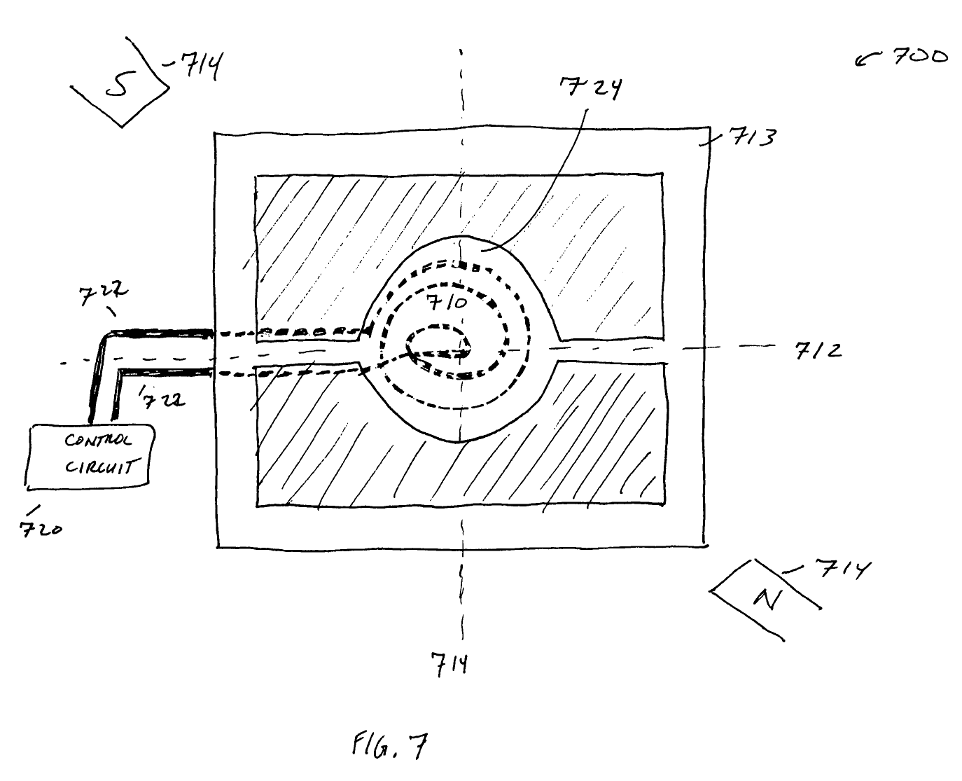

An example MEMS beam director is illustrated by FIG. 7 and includes a mirrored portion (710) that is supported for rotation about a first axis (712) by torsion arms that are, in turn, coupled to a support frame (713). A control circuit (720) is coupled via conductors 722 to a coil (724), which is positioned beneath the mirrored portion of the device. A magnetic field produced by magnets (714) is present across the coil (724) such that periodic current driven into the coil (724) causes the mirror to oscillate back and forth at a periodic rate to perform scanning. Additional MEMS devices are described in further detail in U.S. Pat. No. 5,629,790 to Neukermans et al., which is hereby incorporated by reference.

Alternatively, a MEMS scanner may be driven by other methods and constructed using alternative materials and forms as is known in the art.

A detector 146 may be an appropriate light reactive device (e.g., photo-detector) that has characteristics (e.g., wavelength, sensitivity, bandwidth, cost, power consumption, and size compatibility) suitable for use with other system components for bar code scanning applications. In one example, the detector includes a photodiode circuit (such as a trans-impedance device). In another example, the detector includes a photocell circuit (such as a photo-voltaic device). In still another example, the detector is a phototransistor circuit. In yet another example, the detector is a photoconductor circuit. The detector may include a photodetector circuit, a digitizing circuit, a decoder circuit, and/or other bar code detecting and decoding components as are known to the art.

In some configurations, optical alignment between the beam source and the beam director for FIGS. 2, 3 and 5 may be made easier by maintaining close proximity between the respective enclosures as a result of the natural alignment of the users hand (i.e., the bone structure of the user's hand maintains the orientation of the beam source with respect to the beam director). Moreover, utilizing an oversized mirror in the beam director device can further mitigate potential misalignment issues. Various additional optical elements (e.g., a lens such as a tele-centric lens (138, 358, etc.)) can be used to assist in directing the beam onto the beam director device.

Wireless couplings that are described herein may be an appropriate wireless communication link. Example wireless communication formats may include: radio frequency (RF) communication, infra-red (IR) communication, communication under the “bluetooth” standard, and communication under the IEEE 802.11 standard.

Although the invention has been described herein by way of exemplary embodiments, variations in the structures and methods described herein may be made without departing from the spirit and scope of the invention. For example, the positioning of the various components may-be varied. Individual components and arrangements of components may be substituted as known to the art. Since many embodiments of the invention can be made without departing from the spirit and scope of the invention, the invention is not limited except as by the appended claims.

1. A bar code scanner, comprising:
a first body including a beam source;
a second body configured for movement relative to the first body in a manner adapted for temporary alignment with the first body;
a beam director; and
a detector, wherein the beam director is included in the second body.

2. The bar code scanner of claim 1, wherein temporary alignment corresponds to momentary alignment.

3. The bar code scanner of claim 1, wherein: the beam director is physically coupled to the second body and the detector is physically coupled to the first body.

4. The bar code scanner of claim 1, wherein the detector is physically coupled to the second body.

5. The bar code scanner of claim 1, wherein the beam director and the detector are physically coupled to the second body.

6. The bar code scanner of claim 1, further comprising a third body that includes the detector.

7. The bar code scanner of claim 1, wherein the beam source is fixedly coupled to a first substrate and the beam director is fixedly coupled to a second substrate, wherein each of the substrates are physically separated from one another.

8. The bar code scanner of claim 7, wherein the detector is fixedly coupled to one of: the first substrate, the second substrate, and a third substrate, wherein each of the substrates are physically separated from one another.

9. The bar code scanner of claim 1, wherein the beam source is fixedly coupled to a first substrate, the beam director is fixedly coupled to a second substrate, and the detector is fixedly coupled to the second substrate, wherein each of the substrates are physically separated from one another.

10. The bar code scanner of claim 1, further comprising: at least one portable power source that is coupled to at least one of the beam source, the beam director, and the detector.

11. The bar code scanner of claim 10, wherein the portable power source comprises at least one of a battery and a power control circuit that is battery powered.

12. The bar code scanner of claim 1, further comprising a first ring that is arranged to be worn on a first finger of a user's hand, and a second ring that is arranged to be worn on a second finger of the user's hand, wherein a first substrate is affixed to a first surface of the first ring, and wherein a second substrate is affixed to a seconds surface of the second ring.

13. The bar code scanner of claim 12, further comprising a switching apparatus that is formed on at least one of the first and second rings, wherein the switching mechanism is operable to selectively activate at least one of the beam source, the beam director, and the detector.

14. The bar code scanner of claim 12, further comprising an electrical contact that is formed on at least one of the first and second rings, wherein the electrical contact is operable to communicate information between at least two of the beam source, the beam director, and the detector.

15. The bar code scanner of claim 1, further comprising a first ring that is arranged to be worn on a first finger of a user's hand, and a second ring that is arranged to be worn on a second finger of the user's hand, wherein a first substrate is integrally formed with a first surface of the first ring, and wherein a second substrate is integrally formed with a second surface of the second ring.

16. The bar code scanner of claim 1, further comprising a glove that is arranged to be worn on a user's hand, wherein a first substrate is affixed to a first surface of the glove about a first finger of the users hand, and wherein a second substrate is affixed to a second surface of the glove about a second finger of the user's hand.

17. The bar code system of claim 16, further comprising control electronics that are affixed to the glove about at least one of a back of the user's hand and a wrist of the user's hand, wherein the control electronics are operable to communicate with at least one of the beam source, the beam director, and the detector.

18. The bar code system of claim 1, wherein the beam source further comprises an optical device; and
at least one of: a light emitting diode (LED) or a laser diode; wherein the optical device includes at least one of a converging device, a diverging device, a focusing device, a clipping device, a refracting device, a diffracting device, an anti-stigmatism device, a filtering device, a tele-centric lens, a spherical lens, a holographic lens, a prism, a clipping window, and a collimating lens.

19. The bar code system of claim 1, wherein the beam director comprises an optical device; and
at least one of: a galvanometer, a oscillating mirror device, a MEMS device;
wherein the optical device corresponds to at least one of a converging device, a diverging device, a focusing device, a clipping device, a refracting device, a diffracting device, an anti-stigmatism device, a filtering device, a tele-centric lens, a spherical lens, a holographic lens, a prism, a clipping window, and a collimating lens.

20. The bar code system of claim 1, wherein The detector comprises a decoder circuit and at least one selected from the group of a photodiode circuit, a photocell circuit, a phototransistor circuit, or a photoconductor circuit.

21. The bar code system of claim 20, wherein the decoder circuit is operable to convert scanned signals into decoded digital signals.

22. The bar code system of claim 20, further comprising an optical device corresponding to at least one of a converging device, a diverging device, a focusing device, a clipping device, a refracting device, a diffracting device, an anti-stigmatism device, a filtering device, a tele-centric lens, a spherical lens, a holographic lens, a prism, a clipping window, and a collimating lens.

23. A bar code scanner that is arranged to scan a bar code label that is located within a field of view, the bar code scanner comprising:
a first housing;
a beam source located within the first housing, wherein the beam source is operable to selectively provide a light beam;
a second housing physically separate from the first housing;
a beam director, wherein the beam director is operable to receive the light beam from the beam source and provide a scan beam in a field of view such that light is reflected from a bar code symbol in response to the scan beam; and
a detector, wherein the detector is operable receive the reflected light and provide a detection signal, wherein the beam director is located within the second housing.

24. The bar code scanner of claim 23, wherein the detector is located within the first housing.

25. The bar code scanner of claim 23, wherein the detector is located within the second housing.

26. The bar code scanner of claim 23, further comprising: a third housing that is physically separated from the first housing and the second housing, wherein the detector is located within the third housing.

27. The bar code scanner of claim 23, further comprising an optical device that is affixed about an aperture of the first housing such that the light beam is processed prior to reception by the beam director.

28. The bar code scanner of claim 23, further comprising an optical device that is affixed about an aperture of the second housing such that the light beam is processed prior to reception by the beam director.

29. The bar code scanner of claim 23, further comprising an optical device that is affixed about an aperture of the second housing such that the scan beam that is provided by the beam director is processed prior to projection in the field of view.

30. The bar code scanner of claim 23, further comprising an optical device that is affixed about an aperture of the second housing such that the light reflected from the bar code is processed prior to reception by the detector, wherein the detector is located within the second housing.

31. The bar code scanner of claim 27, wherein the optical device corresponds to at least one of: a converging device, a diverging device, a focusing device, a clipping device, a refracting device, a diffracting device, an anti-stigmatism device, a filtering device, a tele-centric lens, a spherical lens, a holographic lens, a prism, a clipping window, and a collimating lens.

32. The bar code scanner of claim 23, further comprising processing electronics that are wirelessly coupled to at least one of the beam source, the beam director, and the detector.

33. The bar code scanner of claim 23, further comprising control electronics that are connected to at least one of the first housing and the second housing such that power is selectively provided to at least one of the beam source, the beam director, and the detector by the control electronics.

34. The bar code scanner of claim 23, further comprising processing electronics that are connected to at least one of the first housing and the second housing such that information is communicated between the processing electronics and at least one of the beam source, the beam director, and the detector.

35. The bar code scanner of claim 23, wherein the first housing and the second housing include separate battery powered sources.

36. A bar code scanning system comprising:
a computer operable to receive data; and
a bar code scanner operable to send data to the computer, wherein the bar code scanner comprises:
a first housing,
a beam source physically coupled to the first housing,
a second housing that is physically separated from the first housing,
a beam director, and
a detector, wherein the beam director is physically coupled to the second housing;
the beam director is operable to receive light from the beam source and scan a beam across a bar code symbol;
the detector is operable to receive at least a portion of light reflected from the bar code symbol and produce a detection signal; and
a transmission circuit operable to transmit data corresponding to the detection signal to the computer.

37. The bar code scanning system of claim 36, the bar code scanner further comprising: processing electronics operable to receive and decode the detection signal to produce the data corresponding to the detection signal.

38. The bar code scanning system of claim 36, wherein the computer is further operable to transmit data and the bar code scanner is farther operable to receive data from the computer, and
the bar code scanner further comprises: processing electronics operable to control power supplied to at least one of the beam source, the beam director, or the detector in response to data received from the computer.

39. The bar code scanning system of claim 36, wherein the computer is further operable to transmit data and the bar code scanner is further operable to receive data from the computer; and the bar code scanner device further comprises: processing electronics that are operable to control the activation of at least one of The beam source, the beam director, or the detector in response to data received from the computer.

40. A method of scanning a bar code symbol that is located within a field of view, the method comprising:
providing a light beam from a beam source that is located within a first housing;
directing a scanning beam with a beam director over the bar code symbol in response to the light beam, wherein the beam director is located within a second housing that is different from the first housing;
detecting, in response to the scanning beam, at least a portion of reflected light from the bar code with a detector; and
generating a signal with the detector in response to a detected amplitude of the reflected light from the bar code.

41. The method of claim 40, farther comprising: decoding the signal to form digital information, evaluating the digital information to identify a valid bar code, and shutting power associated with at least one of the beam source, the beam director, and the detector after the valid bar code is identified.

42. The method of claim 40, further comprising: decoding the signal to form digital information, communicating the digital information to a host computer via at least one of a wired interface and a wireless interface.

43. A method, comprising:
forming a beam of light with a beam source that is located in a first body;
temporarily aligning the beam of light with a beam scanner that is located in a second body;
scanning the beam of light over a field-of-view; and
detecting a pattern of light scattered by an optical indicia in the field-of-view.

44. The method of claim 43, wherein temporarily aligning the beam of light with a beam scanner includes receiving the beam of light and redirecting the beam of light to the beam scanner.

45. The method of claim 43, wherein temporarily aligning the beam of light with a beam scanner includes aligning at least a portion of the first body with the at least another portion of the second body.

46. The method of claim 43, wherein temporarily aligning the beam of light with a beam scanner includes aligning a first ring worn on a first finger with a second ring worn on a second finger.

47. The method of claim 46, wherein the first body is fixedly coupled to a first surface of the first ring, and the second body is fixedly coupled to a second surface of the second ring.

48. The method of claim 43, wherein temporarily aligning the beam of light with a beam scanner includes wearing a flexible substrate carrying the first body and the second body.

49. A scanned beam image capture system, comprising:
a first body that includes a means for producing a beam of light;
a second body that includes at least one of:
a means for receiving the beam of light and scanning the beam of light across a field of view; and
a means for detecting at least a portion of light scattered from the field of view; and
a means for temporarily aligning the first body to the second body.

50. The scanned beam image capture system of claim 49, further comprising: a third body that includes one of the means for receiving the beam of light and scanning the beam of light across a field of view, and the means for detecting at least a portion of light scattered from the field of view.

51. The scanned beam image capture system of claim 49, wherein the first body includes at least one of: a means for shaping the beam of light, a means for collimating the beam of light, a means for filtering the beam of light, a means for focusing the beam of light, and the means for temporarily aligning the first body with the second body.

52. The scanned beam image capture system of claim 49, wherein the second body includes at least one of: a means for shaping the beam of light, a means for collimating the beam of light, a means for filtering the beam of light, a means for focusing the beam of light, and the means for temporarily aligning the first body with the second body.

53. The scanned beam image capture system of claim 49, wherein the means for detecting includes at least one of: a means for filtering, and a means for excluding.
